(19) United States
(12) Patent Application Publication
(10) Pub. No.: US 2018/0053122 A1
(43) Pub. Date: Feb. 22, 2018

(54) SYSTEM AND METHOD FOR MANAGING TRAVEL ARRANGEMENTS

(71) Applicant: GEMSTONE TRAVEL MANAGEMENT SYSTEMS INC., Sherwood Park (CA)

(72) Inventors: Jianfei Xu, Edmonton (CA); Thomas McHale, Sherwood Park (CA)

(21) Appl. No.: 15/243,395

(22) Filed: Aug. 22, 2016

(51) Int. Cl. G06Q 10/02

(52) U.S. Cl. CPC G06Q 10/025

(57) ABSTRACT

A logistics system is provided for booking transportation and accommodation in remote locations and tracking transportation and accommodation data. The system comprises one or more customizable applications associated with the system; one or more datasets for storing data associated with said one or more applications; a processor; a memory that stores instructions from each of said one or more customizable applications. Said instructions, when executed by the processor, cause the processor to perform operations comprising detecting a user; identifying the user from the group consisting of a traveller, a travel and accommodation coordinator and an administrator; displaying targeted information to the user based the identification of the user wherein accommodation and travel booking information is displayed when the user is a traveller; travel and accommodation booking information, group booking information and flight information is displayed when the user is a travel and accommodation coordinator and information selected from the group consisting of flight and accommodation occupancy, traveller details, summary reporting and operational information are displayed if the user is an administrator; receiving input from the user; executing steps consisting of travel and accommodations booking and itinerary display steps when the user is a traveller; travel and accommodation booking, traveller profiles display and group booking steps when the user is a travel and accommodation coordinator and report generating steps when the user is an administrator. A method is also provided for booking and tracking transportation and accommodation in remote locations and tracking transportation and accommodation data.

### FIELD OF THE INVENTION

The present invention relates to logistics systems and methods for booking, managing and monitoring travel and accommodation.

### BACKGROUND OF THE INVENTION

In recent years, online travel and accommodation booking via the Internet has become ubiquitous. There are numerous websites by which a user can book commercial flights, rent cars and make hotel reservations around the world for both business and leisure.

However, with respect to remote travel to non-public locations, such as remote worksites and work camps, very few resources are available in terms of consolidated travel and accommodation bookings. Companies that own remote, fly-in, fly-out operations are dependent on costly charter bookings and inefficient camp reservation by phone or in person. The process of booking flights, ground transportation and accommodation individually is cumbersome for the travel coordinators making arrangements, and cancellations or changes to travel itineraries are difficult to keep track of, leading to empty flights and empty rooms and in many cases to workers arriving at the site with no accommodations arranged.

Furthermore, companies have no easy means of knowing or tracking levels of occupancy or vacancies on flights or in camps, occurrences of cancellations or ‘no-shows’, busy travel times and other information that could help to manage the logistics and costs of travel and accommodation for their remote operations. This is because camp and travel are generally disparate booking processes; there is typically not one repository of information. As such company need to request airlines to provide data on if an employee has traveled or not, and call the camp to see if the employee has a reservation or not.

US Reissue Patent RE42001 teaches a system and method for planning commercial travel schemes and itineraries by maximizing seats on a particular flight or carrier to take advantage of incentives. Historical travel data and statistics can be compiled to provide reports or data to the company; however it does not track missed flights, cancelations nor does book charter flights, or remote camp accommodations.

Canadian Patent No. 2,196,936 teaches a means of managing group bookings by a central administrator in the form of block bookings and handles block booking arrangements with multiple vendors allows for changes in participants and can produce reports and accounting detail on group travel. It is meant only for commercial travel to public locations.

US publication no. 2006/0206363 teaches a software and system for group travel planning that can be done by a single administrator to arrange travel for multiple individuals from multiple origins to a single destination or multiple destinations. It does not provide individual users the ability to book, nor does it track travel information or deal with charter flights or non-public destinations.

US publication number 2006/0106655 teaches a method and system for coordinating the travel itineraries of multiple travelers who are leaving from multiple origins and arriving at the same destination.

US publication number 2013/0346124 teaches a system for determining a group travel destination and corresponding itineraries based on profile data from each individual traveler. US 2002/0123913 teach a layover management system for a flight crew and plans lodging for a flight crew on layover.

Some prior art systems have been developed that relate to remote location, fly-in/fly-out applications.

The website https://innfinity.com/logistics-travel/ describes a software that allows companies like oil & gas companies to lease rooms or blocks of rooms from camps and from the camps of other companies. It also suggests that it could be used with a flight booking function. However there are no means for companies to allow their employees/contractors to book flights and rooms together, or for flight occupancy to be maximized, or for booking efficiency to be reported to the company.

The website http://www.ibsplc.com/products/oil-and-gas-logistics/aviation-logistics teaches a transportation logistics system and an accommodation/camp logistics system, however, it appears that these systems are not linked.

The website http://www.osmotion.com.au/sam teaches flight and accommodations components; however, it is not clear if there is ability to book both charter and scheduled flights.

There is therefore a need the art for methods and systems for travel booking and travel data reporting that can be used by both employees and companies for remote offsite operations.

### SUMMARY

A logistics system is provided for booking transportation and accommodation in remote locations and tracking transportation and accommodation data. The system comprises one or more customizable applications associated with the system; one or more datasets for storing data associated with said one or more applications; a processor; a memory that stores instructions from each of said one or more customizable applications. Said instructions, when executed by the processor, cause the processor to perform operations comprising detecting a user; identifying the user from the group consisting of a traveller, a travel and accommodation coordinator and an administrator of a company; displaying targeted information to the user based the identification of the user wherein accommodation and travel booking information is displayed when the user is a traveller; travel and accommodation booking information, group booking information and flight information is displayed when the user is a travel and accommodation coordinator and information selected from the group consisting of flight and accommodation occupancy, traveller details, summary reporting and operational information are displayed if the user is an administrator; receiving input from the user; executing steps consisting of travel and accommodations booking and itinerary display steps when the user is a traveller; travel and accommodation booking, traveller profiles display and group booking steps when the user is a travel and accommodation coordinator and report generating steps when the user is an administrator.

A method is also provided for booking and tracking transportation and accommodation in remote locations and tracking transportation and accommodation data. The method comprises the steps of providing a system comprising one or more customizable applications; one or more datasets for storing data associated with said one or more applications; detecting a user; identifying the user from the group consisting of a traveller, a travel and accommodation coordinator and an administrator of a company; displaying targeted information to the user based the identification of the user wherein accommodation and travel booking information is displayed when the user is a traveller; travel and accommodation booking information, group booking information and flight information is displayed when the user is a travel and accommodation coordinator and information selected from the group consisting of flight and accommodation occupancy, traveller details, summary reporting and operational information are displayed if the user is an administrator; receiving input from the user; and executing steps consisting of travel and accommodations booking and itinerary display steps when the user is a traveller; travel and accommodation booking, traveller profiles display and group booking steps when the user is a travel and accommodation coordinator and report generating steps when the user is an administrator.

It is to be understood that other aspects of the present invention will become readily apparent to those skilled in the art from the following detailed description, wherein various embodiments of the invention are shown and described by way of illustration.

As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a flowchart of one example of how various users access various datasets and applications of the present logistics system; and

FIG. 2 is a flow diagram of one embedment of a method of the present invention.

The drawing is not necessarily to scale and in some instances proportions may have been exaggerated in order more clearly to depict certain features.

### DETAILED DESCRIPTION OF VARIOUS EMBODIMENTS

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

The present invention relates to methods and systems for managing logistics around workforce transportation and accommodations, particularly in the area of remote fly-in, fly-out worksites having limited flights and limited camp accommodations. The present invention can advantageously manage the fly-in-fly-out aspect, as well as coordinating camp logistics, any commercial travel and charter flight components of getting a traveler into and out of the site and arranging accommodation and meals on a single system.

The present system brings elements of flights and accommodation together and allows the company to set business rules relating to worker travel. For example, it may be possible to limit booking of flights to only once a room reservation at the destination has been made, to ensure that workers arriving on site have confirmed accommodations. This can prevent costly last minute room allocations or needing to accommodate the worker at an offsite location.

In the present invention, when a traveler knows their work schedule, they can direct a travel and accommodation coordinator to review and book seats on available charter and/or commercial air travel options via examining the Global Distribution System that is a large, universal database of flights, both commercial and some charter from which flight bookings are made. The travel and accommodation coordinator can also, via the same present system, book transportation from the airport or airstrip to the campsite, as well as booking the camp lodging using a single, integrated platform or system. The travel and accommodation coordinator can be internal or external to the company; if they are external the system can be provided to them by the company

The present invention may also be used by subcontractors; in some embodiments a company may provide subcontractors working on the company's projects with access the to the system to allow workers of the subcontractors to book travel and accommodations via the company's travel and accommodation coordinator or via a travel reservation agent of the subcontractor. In other embodiments, subcontracting businesses may purchase and use the system independently of any particular company, to book travel and accommodations for their workers via a travel and accommodation reservation agent. In either case, the subcontractor can advantageously also benefit from producing and receiving reports on the travel and accommodations activities of their workers, either on the company's particular projects or more holistically for the subcontractor's overall projects.

In a preferred embodiment, the present invention further provides a group booking function to make reservations for an entire aircraft, to maximize occupation on charter flights and to reduce booking times compared to booking each seat individually. Further preferably, the present invention includes a group booking function for accommodation to book rooms a group of employees in a bulk fashion without having to do individual bookings.

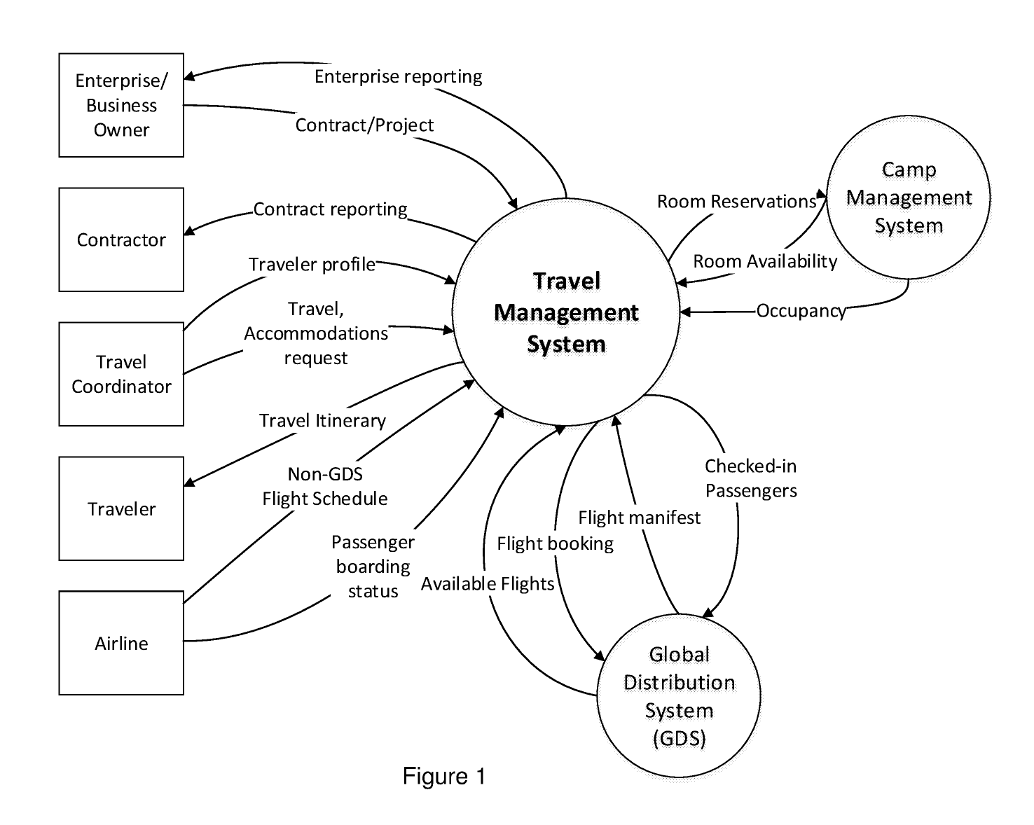

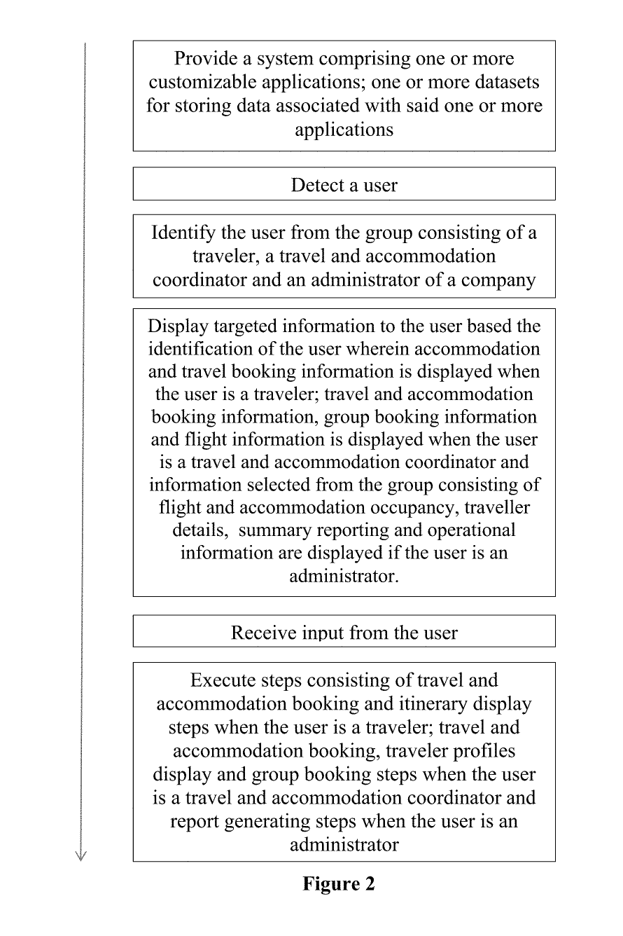

In some instances, the system may also be configured with a traveler portal that allows the traveler to book travel and accommodations independently, without the use of the company's travel and accommodations coordinator. In such cases, the applications of the present system can be accessed conventionally on a computer, or on any portable device or on a mobile device by way of an application downloaded to that device. With reference to FIGS. 1 and 2, the present invention allows multiple users to access and use a singular system in specific ways for specific purposes. At the most limited level, a traveler user has access only to their own itineraries and bookings, with no report generating functions. A subcontractor with company permission to use the system has access to the flight booking information of all of its workers on the project(s) of the company, with some restricted report generating functions. The company's travel and accommodations coordinator will have access to travel and accommodation information of all travelers, as well as group booking capacities. Finally the company has the ability to access the fullest set of information of all travel and accommodations data, as well as more holistic overall reporting of the travel and accommodations aspects of its operations.

By allowing travel reservation subcontractors to book travel and accommodation, the company is able to decentralize the responsibility of bookings of flights and accommodation down to their contractors, while still retaining data on various aspects of the travel and oversight of bookings in the company's camps and on their planes.

The invention further provides means for companies to analyze flight patterns, to determine efficient charter routes and stops and analyze data such as late cancellations and ‘no-show’ passengers. The system is customizable for particular companies for use by their administrators to generate reports and obtain travel and accommodation data. The present system can also centralize and keep track of costs and expenditure related to worker transportation and accommodation.

In the single system of the present invention different users are given permissions to allow them to access specific datasets of the system database and specific applications, based on the party using the system. This allows multiple user types to interface with database and application via different permissions and for different purposes.

In a further preferred embodiment, the present system applications and datasets can be customized without the need to re-write the source code each time. The engine, which is driven by the source code, need only be upgraded when upgrades are required and not each application/database.

The present system can be customized based on company requirements, traveler use requirements, as well as industry standards.

The system thus comprises a universal interface with various datasets, thus supporting multi-user types by providing access to particular datasets based on user type. The present system further provides rapid customization development.

The present system allows companies to develop various application solutions using the same system. As more functions are required to add to the system, new solutions can be developed and integrated with the existing system. Since the engine of the present system is able to support a variety of applications, only one platform is required to maintain the various applications.

Each application server requires one dedicated port to run, but multi-application servers are allowed to run on the same machine. The system can have as many application servers as needed. The server agent and application is preferably able to run on most well-known operation systems commercially used. All data transfer through the application server is preferably encrypted in binary format, and can only be interpreted by the system itself. The connection between database server and application server is preferably established through a local network. The connection between application server and an end user can be achieved through local network or internet by using TCP/IP, although any number of known means in the art could also be used without departing from the scope of the invention.

In the present system, multiple types of users have unique accesses to the system for unique purposes. A travel coordinator can use the system to book flights, be they charter or commercial, accommodations, ground transportation, meals etc.

It is also possible, in the case of charter flights, for the present system to be used in conjunction with charter reservation systems to allow an airline check in agent to check in travelers for flights, and for the check-in data to then be included in reporting to the company. The present system can work with flight plan management systems like for example Sabre™, or the present system can work in place of specific parts of flight plan managements systems, like check-in parts, or it is also possible for the present system to replace entirely existing flight plan management systems. By allowing the check in agent to check-in travelers on the present system, travel check-ins are more conveniently streamlined and managed in one system.

Further advantageously, the present system is able to better control and collect data on traveler interactions, which in turn improves the reporting capabilities and data that can be reported to the enterprise users of the system. A company administrator can use the system to present a holistic view of all its subcontractors' bookings as well as check on lodging availability at a high level to aid decision making.

In one embodiment, it is also possible to book an entire charter flight by the travel and accommodation coordinator using stored identification, preferences and other data of all of the travelers. This process of booking an entire flight from a set of traveler data provides greater efficiency than booking those same travelers individually one by one. In a further preferred aspect of the present invention, the present system is vertically integrated with camp accommodation management software, to allow travelers, company travel coordinators or travel reservation agent of the subcontractor to book camp accommodations using applications of the present system to unify and simplify the process for such users. While the camp accommodation management software is used for checking in and out travelers, vertical integration with the present system advantageously allows for check in and check out data to be accessible by the present system for report generating purposes. Furthermore, after check-in the present system is still able to make any adjustments to the traveler's accommodation booking such as room type, check out date, traveler's work shifts, project account code to which the stay is to be charged, among others. Since the present accommodations booking system is vertically integrated with camp accommodation software, these changes can be realized at the camp accommodation site.

By consolidating travel and accommodations booking information from the present system with accommodation check in information from the vertically integrated camp accommodation software, the present system is able to generate consolidated reports covering all aspects of travel and accommodation, giving the company a fuller picture of the use of its flights and camps.

The vertical integration with camp accommodation management software with the present system provides more data on camp usage, occupancy, capacity and other information that can lead to better planning of camp staffing needs, maintenance scheduling, housekeeping scheduling, among other factors.

The present logistics system advantageously translates reservation usage of the system into data on travel operations of the company. This data is collected and can be interpreted, using applications of the company module, into useful metrics. The company user is then able to use applications of the present system to create reports based on the data to better examine and assess travel operations. In a preferred embodiment applications of the present system can create either preset reports or customizable reports based on parameters selected by the company user.

Reports generated by applications of the company module of the present system can be used to determine travel operation metrics such as camp and flight occupancy, flight utilization, number of flights meeting a minimum occupancy level, occurrences of booking cancelations in the forms of last minute cancellations or ‘no-shows’, camp room availability, charter costs, commercial flight costs, camp costs, among others.

In a further preferred embodiment the company can modify travel and accommodation settings in order to maximize occupancy, schedule shut-downs, redistribute workers etc. Access and modification of applications can be done via instructions to an external systems manager.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A logistics system for booking transportation and accommodation in remote locations and tracking transportation and accommodation data, said system comprising:
a. one or more customizable applications associated with the system;
b. one or more datasets for storing data associated with said one or more applications;
c. a processor;
d. a memory that stores instructions from each of said one or more customizable applications, wherein said instructions, when executed by the processor, cause the processor to perform operations comprising:
i. detecting a user;
ii. identifying the user from the group consisting of a traveller, a travel and accommodation coordinator and an administrator of a company;
iii. displaying targeted information to the user from specific datasets based the identification of the user wherein accommodation and travel booking information is displayed when the user is a traveller; travel and accommodation booking information, group booking information and flight information is displayed when the user is a travel and accommodation coordinator and information selected from the group consisting of flight and accommodation occupancy, traveller details, summary reporting and operational information are displayed if the user is an administrator;
iv. receiving input from the user;
v. executing steps of specific applications consisting of travel and accommodations booking and itinerary display steps when the user is a traveller; travel and accommodation booking, traveller profiles display and group booking steps when the user is a travel and accommodation coordinator and report generating steps when the user is an administrator.

2. The system of claim 1, further comprising identifying the user from the group consisting of a subcontractor and a travel reservation agent of the subcontractor;
displaying travel and accommodation booking information and flight information when the user is a travel reservation agent of the subcontractor and information selected from the group consisting of traveler details, summary reporting and operational information when the user is a subcontractor; receiving input from the user and executing steps consisting of travel and accommodations booking, traveller profiles display and itinerary display steps when the user is a travel reservation agent of the subcontractor and report generating steps when the user is a subcontractor.

3. The system of claim 1, wherein the system is customizable based on company to generate specific reports and obtain specific travel and accommodation data.

4. The system of claim 1, wherein said system generates cost tracking and expenditure related reports on travel and accommodations.

5. The system of claim 1, wherein the system is configured for use in association with charter flight plan management systems to perform the operations of checking into a flight when the user is a traveler and report generating related to check-in data when the user is an administrator.

6. The system of claim 5, wherein the system replaces check in functions of the flight plan managements systems.

7. The system of claim 6, wherein the system replaces the flight plan management systems.

8. The system of claim 1, wherein the group booking step comprises booking multiple travelers on a charter flight using stored identification and preference data of the multiple travelers.

9. The system of claim 1, wherein the system is configured to be vertically integrated with a camp accommodation management software to perform steps of camp accommodation check in and check out when the user is a traveler.

10. The system of claim 9, wherein the system executes the steps of check in and check out report generating by accessing check in and check out data from the camp accommodation management software when the user is an administrator.

11. The system of claim 10, wherein after check-in, the system executes the step of adjusting room type, check out date, traveler work shifts or project account code to which the accommodation is to be charged.

12. The system of claim 10, wherein the system executes the steps of consolidated travel and accommodation report generating when the user is an administrator, providing information on use of flights and camps.

13. A method for booking and tracking transportation and accommodation in remote locations and tracking transportation and accommodation data, said method comprising the steps of:
i. providing a system comprising one or more customizable applications;
one or more datasets for storing data associated with said one or more applications;
ii. detecting a user;
iii. identifying the user from the group consisting of a traveller, a travel and accommodation coordinator and an administrator of a company;
iii. displaying targeted information to the user based the identification of the user wherein accommodation and travel booking information is displayed when the user is a traveller; travel and accommodation booking information, group booking information and flight information is displayed when the user is a travel and accommodation coordinator and information selected from the group consisting of flight and accommodation occupancy, traveller details, summary reporting and operational information are displayed if the user is an administrator;
v. receiving input from the user; and
vi. executing steps consisting of travel and accommodations booking and itinerary display steps when the user is a traveller; travel and accommodation booking, traveller profiles display and group booking steps when the user is a travel and accommodation coordinator and report generating steps when the user is an administrator.

14. The method of claim 13, further comprising the steps of identifying the user from the group consisting of a subcontractor and a travel reservation agent of the subcontractor;
displaying travel and accommodation booking information and flight information when the user is a travel reservation agent of the subcontractor and information selected from the group consisting of traveler details, summary reporting and operational information when the user is a subcontractor; receiving input from the user and executing steps consisting of travel and accommodations booking, traveller profiles display and itinerary display steps when the user is a travel reservation agent of the subcontractor and report generating steps when the user is a subcontractor.

15. The method of claim 13, wherein the report generating step is customizable based on company to generate specific reports and obtain specific travel and accommodation data.

16. The method of claim 13, wherein report generating comprising generating reports on cost tracking and expenditure related to travel and accommodations.

17. The method of claim 13, further comprising, in association with charter flight plan management systems, the steps of checking into a flight when the user is a traveler and report generating related to check-in data when the user is an administrator.

18. The method of claim 13, wherein the group booking step comprises booking multiple travelers on a charter flight using stored identification and preference data of the multiple travelers.

19. The method of claim 13, further comprising, in association with a camp accommodation management software, performing the steps of camp accommodation check in and check out when the user is a traveler.

20. The method of claim 19, wherein the step of report generating comprises check in and check out report generating by accessing check in and check out data from the camp accommodation management software when the user is an administrator.

21. The method of claim 20, wherein after the step of camp accommodation check in, the method comprises the step of adjusting room type, check out date, traveler work shifts or project account code to which the accommodation is to be charged.

22. The method of claim 20, wherein the step of report generating comprises consolidated travel and accommodation report generating when the user is an administrator, providing information on use of flights and camps.
